(19) United States
(12) Patent Application Publication
(10) Pub. No.: US 2026/0075466 A1
(43) Pub. Date: Mar. 12, 2026

(54) SEMI-SUPERVISED HIERARCHICAL MONITORING OF PERFORMANCE MEASURES IN ROUTED OPTICAL NETWORKS

(71) Applicants: Cisco Technology, Inc., San Jose, CA (US); Politecnico di Milano, Milano (IT)

(72) Inventors: Pietro Invernizzi, Varese (VA) (IT); Claudio Crognale, Monza (MB) (IT); Roberto Manzotti, Vaprio d’Adda (MI) (IT); Giovanni Martinelli, Monza (MB) (IT); Antonino Maria Rizzo, Castelvetrano (TP) (IT); Giacomo Boracchi, Buccinasco (IT); Cesare Alippi, Mandello del Lario (LC) (IT); Michelangelo Olmo Nogara Notarianni, Milano (MI) (IT); Luca Magri, Milan (IT); Stefano Binetti, Monza (MB) (IT)

(21) Appl. No.: 18/938,978

(22) Filed: Nov. 6, 2024

Related U.S. Application Data
(60) Provisional application No. 63/693,303, filed on Sep. 11, 2024.

(51) Int. Cl. H04W 28/08; H04L 43/062

(52) U.S. Cl. CPC H04W 28/0958; H04L 43/062

(57) ABSTRACT

A method performed by a network monitor configured to communicate with network devices of a network. The method involves receiving one or more network performance measures from network devices of a network; evaluating the one or more network performance measures to produce a change statistic indicative of a change in the one or more network performance measures; upon detecting that the change statistic exceeds a detection threshold, constructing a descriptor vector that includes statistical change measures for corresponding ones of the one or more network performance measures; using a probability density estimation model for pre-computed descriptor vectors that represent a normal condition of the network, determining whether the descriptor vector represents an outlier indicative of an abnormal condition of the network; and when the descriptor vector represents the outlier, sending an alarm that indicates the abnormal condition.

### PRIORITY CLAIM

This application claims priority to U.S. Provisional Application No. 63/693,303, filed Sep. 11, 2024, the entirety of which is incorporated herein by reference.

### TECHNICAL FIELD

The present disclosure relates generally to monitoring networks.

### BACKGROUND

Routed Optical Networks (RONs) manage routing of optical traffic passing through metro and long-haul optical links. To optimize operational efficiency, predict maintenance needs, and identify deteriorations in fiber links, a common approach steadily acquires and monitors data in the form of a performance measure (PM), presented as a time series of values representing a transmission status along each link. A RON (more generally referred to herein as a “system”) in normal conditions (i.e., in the absence of failure conditions) undergoes natural shifts over time, known as “system breath,” which prevents using traditional statistical tests to monitor PM data, as the tests assume a temporal independence of the PM data. Specifically, PMs present non-uniform fluctuations that are difficult to predict and distinguish from dynamic fluctuations resulting from a change in the system status. Moreover, system changes might arise from nonlinear effects in the transmission, making the system changes challenging to characterize and identify using expert-defined rules.

### BRIEF DESCRIPTION OF THE DRAWINGS

FIG. 1 is a block diagram of an example routed optical network (RON) in which a change detection (CD) method may be implemented, according to an example embodiment.

FIG. 2 shows a timeline over which the CD method monitors changes of a performance metric (PM), according to an example embodiment.

FIG. 3 shows processing layers or operations of the CD method, according to an example embodiment.

FIG. 4 shows use of a normal discrepancy (ND) test by a detection layer of the CD method to jointly evaluate concurrent time series for multiple PMs at a first time, according to an example embodiment.

FIG. 5 shows use of the ND test to jointly evaluate the concurrent time series for the multiple PMs at a second time, according to an example embodiment.

FIG. 6 shows a descriptor vector produced by a build descriptor layer of the CD method, according to an example embodiment.

FIG. 7 shows timeline plots for descriptor vectors generated by the build descriptor layer responsive to detected changes indicated by the detection layer, according to an example embodiment.

FIG. 8 shows training of an artificial intelligence model (e.g., a probability density estimation (PDE) model) of a validation layer of the CD method, according to an example embodiment.

FIG. 9 is an illustration of a trained PDE model that results from the training shown in FIG. 8, according to an example embodiment.

FIG. 10 is a flowchart of the CD method, according to an example embodiment.

FIG. 11 illustrates a hardware block diagram of a computing device that may perform functions associated with operations discussed herein, according to an example embodiment.

### DETAILED DESCRIPTION

### Overview

In an embodiment, a method is provided that is performed by a network monitor configured to communicate with network devices of a network. The method involves receiving one or more network performance measures from network devices of a network; evaluating the one or more network performance measures to produce a change statistic indicative of a change in the one or more network performance measures; upon detecting that the change statistic exceeds a detection threshold, constructing a descriptor vector that includes statistical change measures for corresponding ones of the one or more network performance measures; using a probability density estimation model for pre-computed descriptor vectors that represent a normal condition of the network, determining whether the descriptor vector represents an outlier indicative of an abnormal condition of the network; and when the descriptor vector represents the outlier, sending an alarm that indicates the abnormal condition.

### Example Embodiments

Embodiments presented herein are directed to a semi-supervised hierarchical change detection (CD) method (also referred to simply as a “CD method” in the ensuing description) that performs network monitoring. The CD method can be applied to a multi-channel Dense Wavelength Division Multiplexed (DWDM) fiber network (e.g., a RON) to detect performance deterioration of the multi-channel DWDM fiber network, which enables the CD method to detect faults when transmission along a DWDM fiber is suddenly interrupted, and when transmission performance of the fiber slowly degrades and there are no errors in transmitted data. The latter feature is important for properly managing the RON because it provides a chance to anticipate the occurrence of events such as traffic loss and bit errors in transmitted frames. This can be especially advantageous to an organization that monitors the RON, but does not own or monitor an optical line system that provides DWDM interconnections.

In particular, the CD method may monitor a single PM or multiple PMs simultaneously (i.e., one or more PMs) to fully grasp a system status. The CD method does not depend on transmission-dependent or expert-defined thresholds and is therefore suited for use in multiple RONs. Moreover, the CD method detects problems when they arise, before total breakdown occurs, and raises alarms for possible faults. The CD method is described in the context of an optical network by way of example. The CD method applies equally to non-optical networks. By way of example, the ensuing description focuses on multiple PM data analysis performed by the CD method. It is understood that the CD method may also perform single PM data analysis.

The CD method operates in an environment in which deteriorations of network performance measures (referred to simply as “performance measures”) represent statistical changes and indicate potential issues in transmission quality. While traditional change detection methods struggle to distinguish significant deteriorations from minor fluctuations, hence being prone to raising false alarms, the CD method presented herein is implemented as a hierarchical (i.e., multi-level) CD method that integrates statistical and machine learning (ML) techniques. In particular, a detection layer of the CD method extracts a change statistic from input PMs and identifies candidate changes as samples that exceed a detection threshold. The changes that exceed the detection threshold are then validated by building a descriptor vector (also referred to as a “change descriptor”) that embeds relevant information of each change, and feeding the descriptor vector to an outlier detection method. The outlier detection method triggers an alarm when there is sufficient statistical evidence to support an assertion that the descriptor vector associated with the identified change is anomalous. In this manner, the CD method provides real-time information with statistical guarantees, implementing an enhanced false alarm control. The enhanced false alarm control filters-out the changes in performance measures deemed significant based on experience.

The CD method may be applied to the following problem formulation in the example context of a RON. In the RON, a RON acquisition device, referred to as a transponder (i.e., a transmitter-responder), represents a process P=P(t) that generates a multivariate “performance monitoring” data stream. Each observation xₜ∈R^{d}˜P(t) is a multivariate vector representing D considered PMs, including, but not limited to, bit error rate (BER), optical signal-to-noise ratio (OSNR), polarization dependent loss (PDL), and average power at a transponder receiver (Rx-POW), for example. In addition, the CD method may be used to monitor PMs acquired from one or more optical channels.

Data streams resulting from the transponder measurements may be non-stationary, meaning they could exhibit trends, seasonal patterns, or other forms of variation in time, and are correlated, meaning that there is a relationship between observations at different points in time. The CD method takes as input an observation xₜ and the previous history {xₜ₋ₖ, . . . , xₜ₋₁}, raising an alarm when there is enough statistical evidence to assert that the sequence {xₜ₋ₖ, . . . , xₜ₋₁}contains a change, namely, that a change that has not been generated by the same process P(t). The goal is to timely detect changes (e.g., performance degradation) and report them, ensuring that issues are identified and addressed before they escalate.

As long as there are no architectural/deployment variations in the RON, it is assumed that the realizations are sampled from the unknown statistical process P(t). For the CD method, this “normal condition” includes several configurations of the RON, i.e., instead of having a unique time-dependent probability distribution, the CD method uses multiple Pᵢ(t), one for each possible “normal state” of the RON. Similarly, different impairments of the system determine diverse post-change conditions P(t).

Unlike a supervised approach in which a training set used for training the CD method in a training phase includes both normal and failure conditions, the CD method operates in a semi-supervised manner. This means that, in one example, during the training phase, the CD method is trained exclusively on normal data (i.e., non-anomalous data) while conditions of the RON are normal (i.e., the RON is operating under normal conditions), without incorporating failure conditions (i.e., anomalous conditions).

At a high-level, the CD method represents a semi-supervised hierarchical CD method to monitor multiple PMs of an optical channel of a RON, simultaneously. The CD method identifies changes in the PMs using a single statistic jointly extracted from all the PMs. The CD method then uses a data-driven outlier detection technique to raise alarms when the changes in the PMs are considered likely to precede a fault.

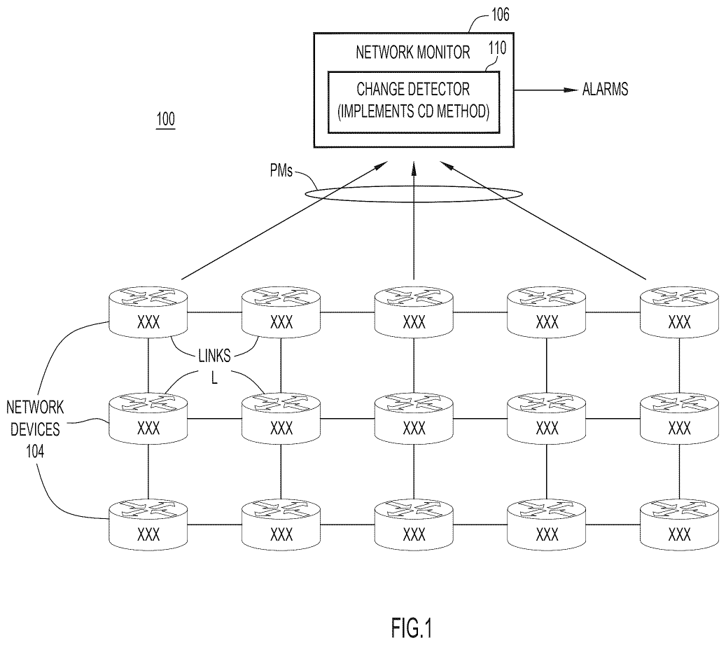

FIG. 1 is a block diagram of an example RON 100 in which the CD method may be implemented. RON 100 may be a multi-channel DWDM fiber network, for example. RON 100 includes optical network devices 104 (e.g., optical routers) connected to each other over fiber links L. Fiber links L may be DWDM fiber links, for example. Optical network devices 104 may include optical transponders having optical transmitters and optical receivers coupled to, and configured to communicate over, fiber links L. RON 100 includes a network monitor 106 configured to communicate with optical network devices 104 over a management network (not shown). Network monitor 106 collects from optical network devices 104 PMs indicative of (operating) conditions of optical network devices 104 and support capabilities for fiber links L. For example, network monitor 106 sends to optical network devices 104 requests for the PMs. Responsive the requests, optical network devices 104 send the PMs to network monitor 106, which receives the PMs. Network monitor 106 may employ any known or hereafter developed techniques and applications to collect the PMs from optical network devices 104. Network monitor 106 includes a change detector 110 that implements the CD method presented herein based on the collected PMs. Upon detecting an abnormal condition of RON 100, the CD method generates an alarm that indicates the abnormal condition, and sends the alarm to a network operator, for example.

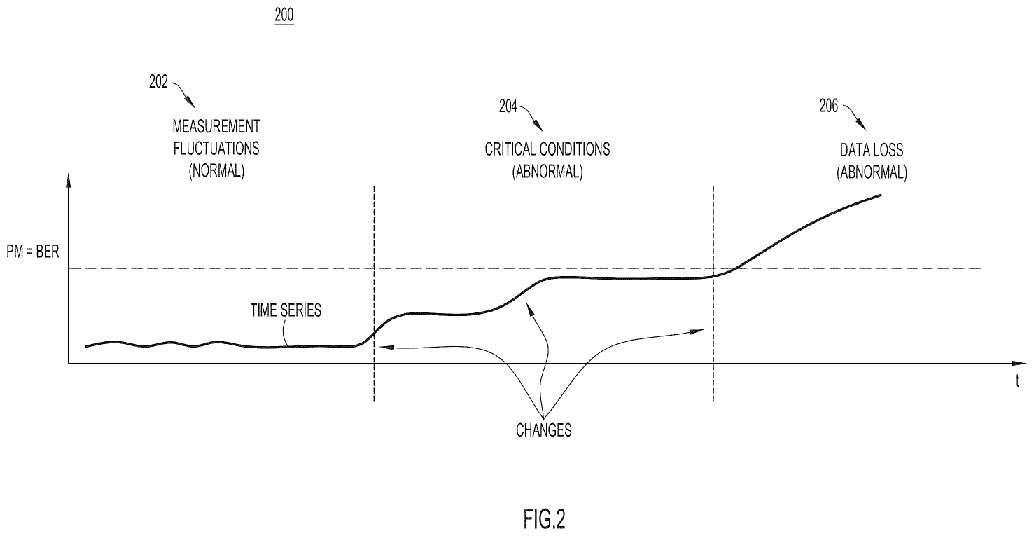

FIG. 2 shows an example timeline 200 over which the CD method monitors changes of a PM (e.g., BER). The PM includes a time series of values of the BER that extend across time segments 202, 204, and 206. During time segment 202, the BER exhibits minor fluctuations or changes indicative of normal conditions of RON 100. Under the normal conditions, RON 100 does not experience “critical conditions” indicative of imminent failures that would cause data transmission loss. The CD method recognizes that the changes during time segment 202 indicate the normal conditions (i.e., the changes and conditions are non-anomalous), and does not raise an alarm. During time segment 204, the BER exhibits more substantive changes. The CD method recognizes that the more substantive BER changes indicate the critical conditions. That is, the CD method recognizes that the more substantive BER changes indicate abnormal or anomalous conditions (also referred to as “degraded conditions”) that will evolve into actual failures. The CD method raises an alarm prior to when the critical conditions mature into the actual failures. During time segment 206, the BER changes rise to significant levels indicative of failure and data loss. The CD method also recognizes the significant rise in BER as abnormal or anomalous conditions.

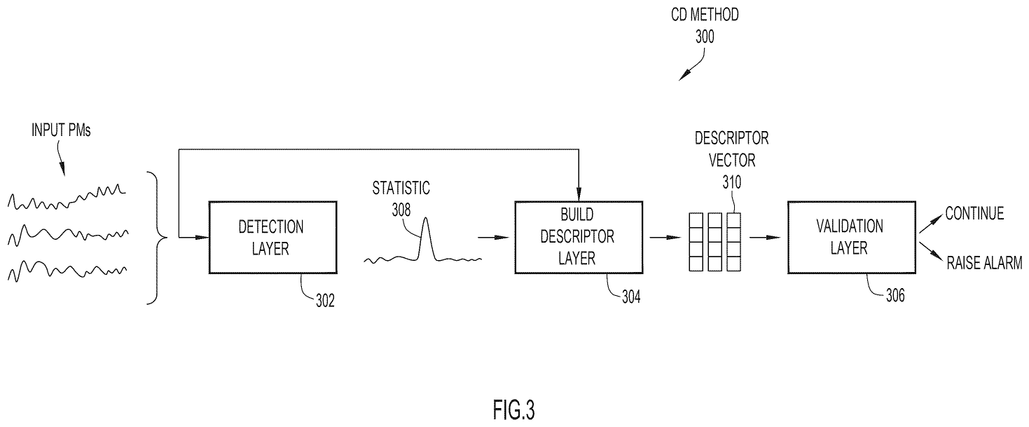

FIG. 3 shows example processing layers 300 of the CD method, according to an embodiment. The processing layers 300 of the CD method include a detection layer 302, a build descriptor layer 304, and a validation layer 306. The detection layer 302 receives as input multiple PMs simultaneously. The detection layer 302 jointly evaluates (i.e., simultaneously analyzes) the multiple PMs using a multivariate statistical change detection test (e.g., a “normal discrepancy” test) to derive a change statistic 308 (which, in the example, is a single change statistic) that detects all changes in the PMs. The changes include natural or normal fluctuations of the PMs that should not be reported as alarms, as well as problematic or abnormal fluctuations. Change statistic 308 represents an overall status of the system. A potential change is flagged when change statistic 308 exceeds a detection threshold.

Once (and, in an example, only when) detection layer 302 identifies a potential change, build descriptor layer 304 constructs a descriptor vector 310 from the PMs that characterize the potential change to each PM. Descriptor vector 310 includes a statistical change measure for each PM. That is, descriptor vector 310 includes statistical change measures for corresponding ones of the PMs. Therefore, descriptor vector 310 may also be referred to as a “multidimensional statistical feature (i.e., change measure) descriptor vector.”

Once the potential change is identified, validation layer 306 (also referred to above as the “outlier detection technique”) determines whether descriptor vector 310 represents an outlier on a probability density estimation (PDE) model or distribution (e.g., a kernel density estimation (KDE) model) of previously computed (i.e., pre-computed) descriptor vectors generated when RON 100 is operating under normal conditions. The PDE model shows a high probability density cloud or cluster (also referred to as a “high-likelihood” cloud or cluster) into which “normal” descriptor vectors corresponding to the normal conditions are most likely to fall. That is, the PDE model has been previously fitted on a dataset of normal PM data during a training phase. Upon determining that the descriptor vector 310 is the outlier, which indicates an abnormal condition of RON 100, validation layer 306 sends an alarm to indicate the abnormal condition. Upon determining that the descriptor vector 310 is not the outlier, which indicates a normal condition of RON 100, validation layer 306 does not send the alarm.

The CD method combines the statistical rigor of detection layer 302, build descriptor layer 304, and validation layer 306 to provide a high level of reliability and effectiveness in detecting deteriorations in RON 100.

The detection layer 302 is now described in further detail. As mentioned above, detection layer 302 jointly evaluates the multiple PMs to derive a single change statistic representing an overall status of RON 100. The detection layer 302 exploits a multivariate statistical change detection test that operates on a non-parametric basis, eliminating the need for assumptions regarding data distribution.

An example of jointly evaluating the multiple PMs uses a normal discrepancy (ND) test (also referred to simply as the “ND”). The ND jointly evaluates time series values (referred to simply as “time series”) for multiple PMs. The ND measures dissimilarities of the time series of the multiple PMs between three sliding windows, including an overall window w and its left and right sub-windows w_{L} and w_{R}. Mathematically, the ND computes a change statistic d_{N} (where N means normal). Change statistic d_{N} is defined as:

$${d}_{N} ( w , {w}^{L} , {w}^{R} ) = n ( ln ( \vert {\sum }_{w} \vert ) - \frac{1}{2} ln ( \vert {\sum }_{{w}^{L}} \vert ) - \frac{1}{2} ln ( \vert {\sum }_{{w}^{R}} \vert ) ) ,$$

where n is the size of the window w and Σ_{w}, Σ_{w}_{^{L}}, Σ_{w}_{^{R}} are covariance matrices computed on the left, right, and overall windows.

Given two random variables X and Y (e.g., a first PM and a second PM), their covariance, which represents a measure of how the two variables change together, is given by:

$$Cov [ X , Y ] = 𝔼 [ ( X - {μ}_{X} ) ( Y - {μ}_{Y} ) ] .$$

Given a set of D random variables X={Xᵢ}ᵢ₌₁^{D} (e.g., D PMs), the covariance matrix Σ_{X} is defined as:

$${\sum }_{X} = [ \begin{matrix}Var [ {X}_{1} ] & ⋯ & Cov [ {X}_{1} , {X}_{D} ] \\ ⋮ & ⋱ & ⋮ \\ Cov [ {X}_{D} , {X}_{1} ] & ⋯ & Var [ {X}_{D} ]\end{matrix} ] .$$

The determinant |Σx| of the covariance matrix Σₓ generalizes variance to multiple dimensions (e.g., D dimensions for the D PMs), and indicates how much the D variables (e.g., the D PMs) vary with relative to each other.

Although the distribution of the change statistic d_{N} is unknown, it depends on the size n of the overall window w and dimension D, and is independent of both the mean and standard deviation of the PMs of a Gaussian distribution generating the PM data.

Detecting that change statistic d_{N} exceeds a detection threshold h, i.e., d_{N} (w, w^{L}, w^{R})>h, triggers build descriptor layer 304 and validation layer 306.

The ND approach allows for simultaneous monitoring of multiple PMs and, because the ND may be independent of mean and standard deviation, it can be considered almost agnostic in most cases to a good approximation. Assuming that PMs are normally distributed, detection threshold h can be estimated a priori from synthetically generated data streams, e.g., by Monte Carlo simulations on data drawn from a Gaussian distribution. Once estimated, detection threshold h may remain fixed. Further details about computing detection threshold h are described below. In other examples, completely non-parametric detection thresholds can be used at detection layer 302 without an assumption of Gaussianity, but the ND approach proves to be very effective given optical performance measures.

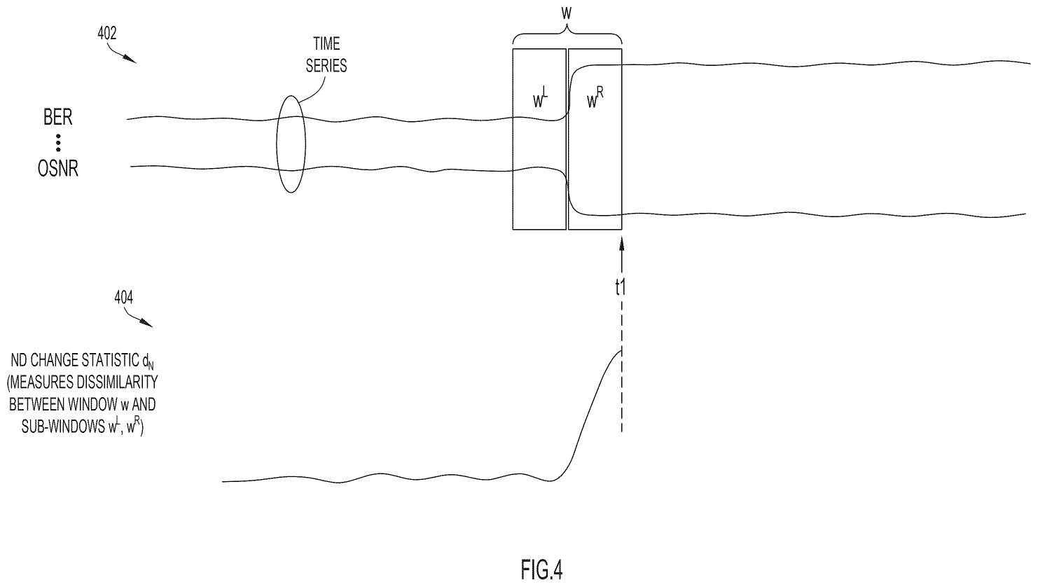

FIG. 4 shows an example of using the ND to jointly evaluate concurrent time series for multiple PMs at a time t1. The multiple PMs include, but are not limited to, BER and OSNR. FIG. 4 includes a top plot 402 that shows the three sliding ND windows w, w_{L}, and w_{R} superimposed on the time series for the PMs at time t1. FIG. 4 includes a bottom plot 404 that shows change statistic d_{N}.

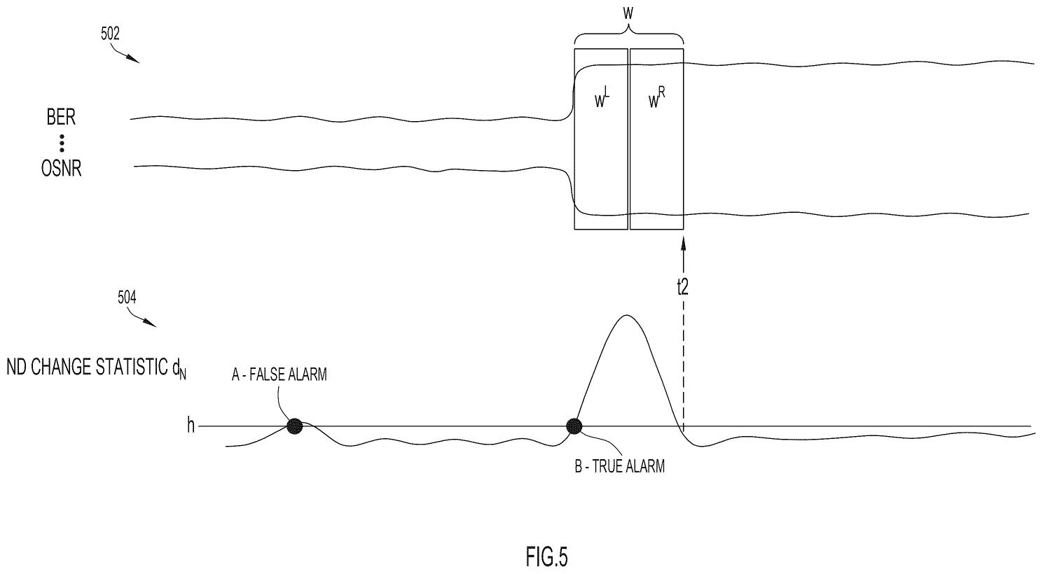

FIG. 5 shows an example of using the ND to jointly evaluate the concurrent time series for the multiple PMs of FIG. 4 at a time t2 after time t1. FIG. 5 includes a top plot 502 that shows the three sliding ND windows w, w_{L}, and w_{R} superimposed on the time series for the PMs at time t2. FIG. 5 includes a bottom plot 504 that shows change statistic d_{N}. Bottom plot 504 also shows detection threshold h. Change statistic d_{N} exceeds detection threshold hat points A and B. Thus, points A and B both trigger next layer evaluations to determine whether the points represent normal fluctuations or abnormal fluctuations. In the example, only point B represents a true alarm.

Referring again to FIG. 3, build descriptor layer 304 (also referred to as the “descriptor building layer”) is now described. When a detected change τᵢ(also referred to a “candidate change”) exceeds detection threshold h, detection layer 302 reports the detected change τᵢ to build descriptor layer 304. The report triggers build descriptor layer 304. Once triggered, build descriptor layer 304 derives a descriptor vector vi, which compactly represents the relevant features of the detected change τᵢ. Build descriptor layer 304 then feeds descriptor vector vi to validation layer 306.

To derive the descriptor vector vi for each detected change, build descriptor layer 304 performs an analysis of a window of time series that coincides with and surrounds the detected change. The window may include both the left and right windows w_{L} and w_{R} defined by the ND, for example. In that case, build descriptor layer 304 computes statistical measures (e.g., the mean and standard deviation) for each PM in each of the left and right windows w_{L} and w_{R}, based on the time series of each PM in each of the left and right windows, for example. Moreover, to ensure robustness, the analysis focuses on relative fluctuations of the statistical measures (e.g., the mean and standard deviation) for each PM compared to an initial window w₀. For example, build descriptor layer 304 computes from the windowed time series for each PM:
a. Right, left, and initial window means μ_{R}, μ_{L}, and μ₀.
b. Right, left, and initial window standard deviations σ_{R}, σ_{L}, and σ₀.
c. Statistical change measure

$$\frac{{μ}_{R} - {μ}_{L}}{{μ}_{0}} , \frac{{σ}_{R} - {σ}_{L}}{{σ}_{0}} .$$

The statistical change measures represent statistical changes or differences (e.g., changes in the mean and standard deviation) of each PM between/across the left and right windows, normalized to the initial window, for example.

The build descriptor layer 304 populates descriptor vector vi with the statistical change measures

$$\frac{{μ}_{R} - {μ}_{L}}{{μ}_{0}} , \frac{{σ}_{R} - {σ}_{L}}{{σ}_{0}}$$

for each of D PMs. Another statistical change measure may be a change in variance Var across the windows, given by

$$\frac{{Var}_{R} - {Var}_{L}}{{Var}_{0}} .$$

Thus, descriptor vector ν₁ is a two-V aro dimensional (2D) vector that has D rows or entries for the D PMs, each row/entry including (e.g., two) statistical change measures. Generally, build descriptor layer 304 computes the descriptor vector such that each row of the descriptor vector represents a (statistical) change in mean, standard deviation (which represents a change measure based on variance), and/or variance of a corresponding PM between the left and right windows, although other characterizations are possible.

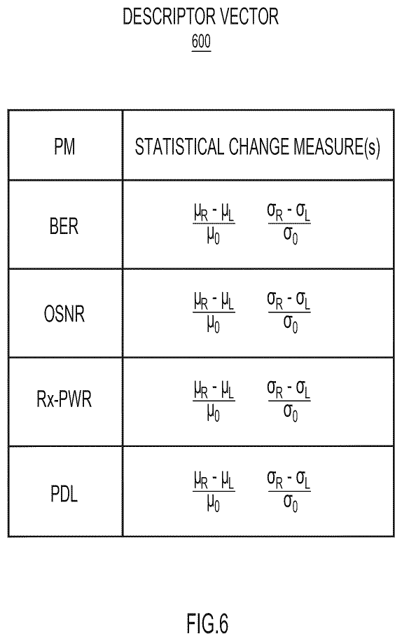

FIG. 6 shows an example descriptor vector 600 produced by build descriptor layer 304 for 4 PMs that include BER, OSNR, Rx-PWR, and PDL. Each row corresponds to one of the PMs, and includes the above-mentioned two statistical change measures.

It is understood that the choice of the PMs and their related extracted features are not unique and depend on the availability of training data and PMs at training time, described below. Moreover, considering additional PMs or increasing the number of features for each PM results in a larger descriptor vector size.

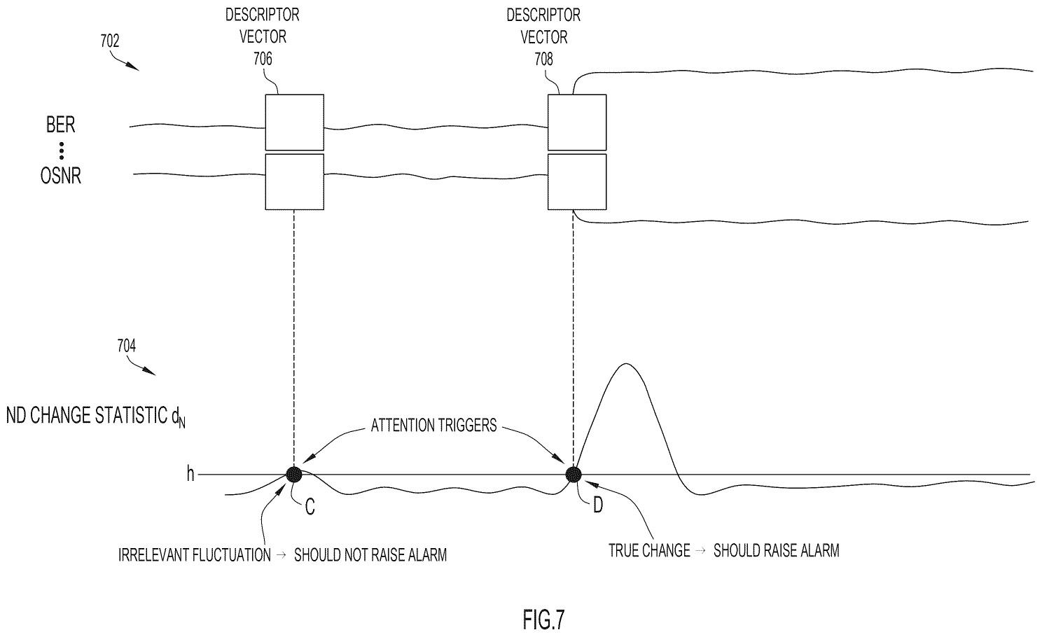

FIG. 7 shows example timeline plots for descriptor vectors generated by build descriptor layer 304 responsive to detected changes indicated by detection layer 302. FIG. 7 shows a top plot 702 and a bottom plot 704 similar to top plot 502 and bottom plot 504 of FIG. 5. Top plot 702 shows descriptor vectors 706 and 708 generated by build descriptor layer 304 responsive to detected changes at points C and D on bottom plot 704 indicated by detection layer 302. Descriptor vectors 706 and 708 respectively represent candidate alarm time series windows to be evaluated by validation layer 306. Build descriptor layer 304 passes descriptor vectors 706 and 708 to validation layer 306 for evaluation.

Referring again to FIG. 3, validation layer 306 is now described. The validation layer 306 validates the detected change r, fed to the validation layer as descriptor vector ν₁ by build descriptor layer 304. The validation layer 306 triggers an alarm when the descriptor vector ν₁ (representing the detected change) is determined to be anomalous and thus indicative of an unseen condition for “normal” PMs processed under normal conditions of RON 100 during training. A “normal” descriptor vector is a descriptor vector constructed by build descriptor layer 304 based on the normal PM data while RON 100 is operating under normal conditions. The normal descriptor vector indicates that RON 100 is operating under the normal conditions, and therefore should not raise an alarm. On the other hand, an “anomalous” or “outlier” descriptor vector (i.e., a descriptor vector that is not a normal descriptor vector) is a descriptor vector constructed by build descriptor layer 304 based on anomalous PM data (i.e., non-normal PM data) while RON 100 is operating under anomalous conditions. The anomalous or outlier descriptor vector indicates that RON 100 is operating under anomalous conditions, and therefore should raise an alarm.

The validation layer 306 includes/employs a PDE model or distribution to determine whether the descriptor vector is normal or anomalous (i.e., an outlier). The PDE model is multidimensional meaning that the PDE includes multiple axes for corresponding ones of the multiple PMs. Each axis corresponds to a statistical change measure of a PM. The PDE model may include a high-likelihood cluster into which normal descriptor vectors for normal conditions of RON 100 (which should not trigger an alarm) are most likely to fall. That is, the PDE model includes a cluster of high-likelihood normal descriptor vectors. The validation layer 306 uses the PDE model to determine whether the descriptor vector is an outlier relative to the high-likelihood cluster. In an example, the descriptor vector does not qualify as an outlier when it is a high-likelihood descriptor vector that falls within the centroid. In that case, no alarm is raised. On the other hand, the descriptor vector qualifies as an outlier when it is a low-likelihood descriptor vector that falls outside of the high-likelihood cluster. In that case, an alarm is raised.

The PDE model may be implemented as an artificial intelligence (AI) model that is trained during a training phase. Once trained, the PDE model may be used during an inference phase to perform the validation of the descriptor vector (and thus the change that it represents) as described above. In one example, the PDE model may be trained exclusively on normal PM data collected when RON 100 is operating under normal conditions, and that result in normal descriptor vectors. In that case, the normal PM data and the normal descriptor vectors that result from the normal PM data represent or indicate the normal condition of RON 100 that should not raise the alarm.

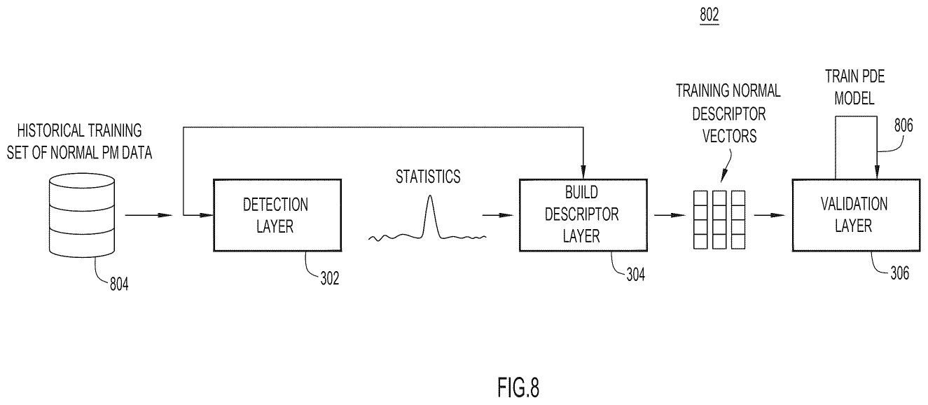

FIG. 8 is a diagram that shows example training 802 of the AI model (i.e., the PDE model) of validation layer 306. Training 802 may be performed in a laboratory environment or directly on a RON to be monitored, for example. Tests performed in the laboratory environment have shown good results for the training procedure. On the other hand, the effectiveness of the training may be improved when carried out on the RON to be monitored. Training 802 collects several days of stable (i.e., normal or non-anomalous) PM data 804 from RON 100 while the RON is operating to forward optical traffic under normal conditions. The PM data 804 represents a large corpus of normal PM training data across multiple PMs. The normal PM training data includes time series for the multiple PMs collected from multiple optical channels over multiple fiber paths of RON 100 in the absence of any faults/failures or deterioration/degradation. Since no faults occur while the normal PM training data is collected, the normal PM training data is considered to characterize a normal operational modality (i.e., operation of RON 100 under normal conditions).

The normal PM training data may be labeled exclusively as “normal.” Alternatively, the normal PM training data may not be labeled. The normal PM training data is applied to the input of the CD method. During training, detection layer 302, build descriptor layer 304, and validation layer 306 process the normal PM training data largely in the manner described above (i.e., for inference stage processing), except for the differences described below. For detection layer 302, even though the normal PM training data is collected from RON 100 without any faults or deterioration of RON 100, “system breathing” of RON 100 may cause the detection layer to identify false changes in the normal PM training data. That is, the normal PM training data may cause the change statistic d_{N} to exceed detection threshold h, repeatedly, which triggers build descriptor layer 304. Once triggered, build descriptor layer 304 extracts normal descriptor vectors from the false changes. The normal descriptor vectors may be labeled exclusively as “normal” for purposes of training. Alternatively, the normal descriptor vectors may not be labeled. The normal descriptor vectors constructed during training are also referred to as “pre-computed” normal descriptor vectors because they are computed prior to inference operation.

Next, at 806, the pre-computed normal descriptor vectors train the PDE model of validation layer 306. That is, the pre-computed normal descriptor vectors update the PDE model. Over time, the training builds a high-likelihood cluster of the PDE model into which the pre-computed normal descriptor vectors are most likely to fall. Essentially, high-likelihood pre-computed normal descriptor vectors generally fall into the high-likelihood cluster, while low-likelihood pre-computed normal descriptor vectors generally fall outside of the high-likelihood cluster. A likelihood threshold may be established to differentiate between the high-likelihood and low-likelihood descriptor vectors. Across the full set of the pre-computed normal PM training data, the system breathing broadens the high-likelihood cluster. The training relies on the assumption that the detected changes identified by detection layer 302 during training do not hinder the transmission of optical traffic, but rather represent intrinsic fluctuations of RON 100 that should not trigger an alarm.

Once the PDE model is trained, the PDE model is used for inference. In an example, the PDE model is not further trained or updated during inference. During inference, when new samples trigger validation layer 306 (e.g., when change statistic d_{N} exceeds detection threshold h, resulting in descriptor vectors), the validation layer computes the likelihood of the descriptor vectors (e.g., as either high-likelihood or low-likelihood descriptor vectors) with respect to the PDE model, which enables the CD method to discriminate between an intrinsic fluctuation (i.e., high likelihood) or a fault (i.e., low likelihood). The true changes are outliers (i.e., low-likelihood descriptor vectors) in this data-driven descriptor space.

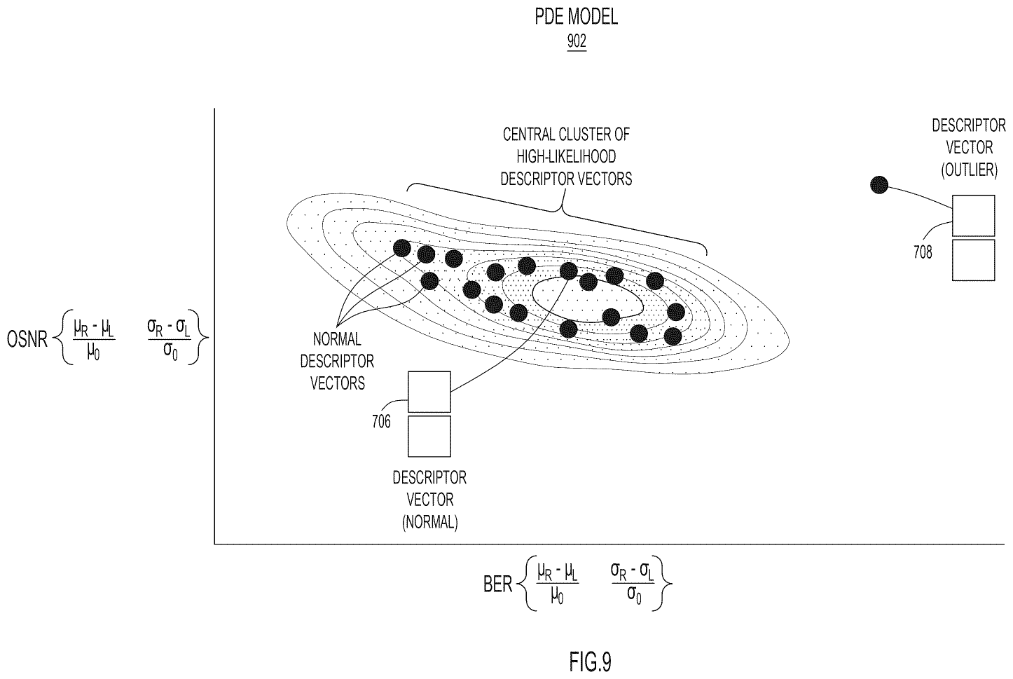

FIG. 9 is an illustration of an example PDE model 902 (e.g., a KDE model) that results from training validation layer 306. PDE model 902 is a trained multi-dimensional PDE model. PDE model 902 includes multiple dimensions/axes for multiple PMs, including BER and OSNR. The multiple dimensions/axes represent the statistical change measures of corresponding ones of the multiple PMs, e.g., a first axis for BER statistical change measure

$$\frac{{μ}_{R} - {μ}_{L}}{{μ}_{0}} ,$$

a second axis for BER statistical change measure

$$\frac{{σ}_{R} - {σ}_{L}}{{σ}_{0}} ,$$

a third axis for OSNR statistical change measure

$$\frac{{μ}_{R} - {μ}_{L}}{{μ}_{0}} ,$$

a fourth axis for OSNR statistical change measure

$$\frac{{σ}_{R} - {σ}_{L}}{{σ}_{0}} .$$

PDE model 902 includes a central high-likelihood cluster (i.e., a high-density region) into which normal descriptor vectors are most likely to fall. That is, the high-likelihood cluster represents high-likelihood normal descriptor vectors. The high-density region represents normal conditions of the network. The high-likelihood descriptor vectors should not raise an alarm. On the other hand, low-likelihood descriptor vectors falling outside of the high-likelihood cluster (i.e., a low-density region) represents outliers indicative of abnormal conditions of the network. The outliers raise alarms.

Referring to FIGS. 9 and 7, during the inference stage, validation layer 306 receives descriptor vector 706 and descriptor vector 708 (taken from FIG. 7). Using PDE model 902, validation layer 306 determines that descriptor vector 706 is a high-likelihood descriptor vector that falls within the high-likelihood cluster, and does not raise an alarm. On the other hand, validation layer 306 determines that descriptor vector 708 is an outlier (i.e., a low-likelihood descriptor vector) that falls outside of the high-likelihood cluster. Descriptor vector 708 is indicative of anomalous conditions of RON 100, and validation layer 306 raises an alarm.

The above described approach enables the same PDE model to be used for monitoring many PMs simultaneously from one or more channels. The PDE model may be the KDE model, which is a statistical technique employed to estimate the probability density function (PDF) of a dataset. A kernel (e.g., Gaussian) is positioned at each data point, and then the kernels are summed or averaged to generate the PDF. Using the KDE model for non-parametric estimation is advantageous because its smoothness filters noise and data uncertainty, making it efficient and adaptable to sparse or irregularly distributed data in high-dimensional spaces. In other examples, different density models may be used, such as Gaussian mixture models (GMMs), mean integrated squared error (MISE) models, or generative models (GMs).

The computation of detection threshold h is now described. The change statistic d_{N} exhibits peaks when changes occur. To reduce false detections, a threshold-based approach is followed. Specifically, when the value of the change statistic d_{N} exceeds detection threshold h, the window is identified as containing a candidate change. To set detection threshold h, a sequential monitoring approach (presented below) is leveraged. Alternatively, a one-shot monitoring approach (also presented below) may be used. The sequential monitoring enables control of false alarms when input samples are independent and identically distributed, for example. In an example setup to establish detection threshold h, samples can be assumed to be identically distributed but, in general, not independent.

The computations below emphasize how detection threshold(s) h may be recomputed when the window size or input dimension changes.

In sequential monitoring, when input samples are independent and identically distributed, the amount of false alarms is controlled. To this end, a set of detection thresholds {hₜ}ₜ is defined to guarantee a fixed false alarm probability a at each time t:

$${P}_{{ϕ}_{0}} ( {d}_{N} ( t ) > {h}_{t} \vert {d}_{N} ( k ) \leq {h}_{k} ∀ k < t ) = α ∀ t \geq 1 .$$

The value of α can be set to exploit the concept of ARL₀=E_{φ}_{₀}[t*], defined as an expected time before a false alarm, where t* is a detection time of the alarm (namely, the change). Under certain conditions, since the detection time t* under φ₀ follows a Geometric distribution, its expected value is 1/α. Under those conditions, it follows that:

$${ARL}_{0} = \frac{1}{{P}_{{ϕ}_{0}} ( {d}_{N} ( t ) > {h}_{t} \vert {d}_{N} ( k ) \leq {h}_{k} ∀ k < t )} ∀ t \geq 1 .$$

Due to difficulties associated with computing conditional probabilities, a Monte Carlo simulation may be performed. This procedure ensures that the final detection threshold outcomes are influenced by preceding values, thereby providing temporal conditioning.

Once-shot monitoring is now described. Since the CD method may employ a semi-parametric statistic (e.g., the normal discrepancy), which is not affected by input PM scaling or shift in the means, detection threshold h can be computed with a Monte Carlo simulation that uses synthetic data drawn from a Gaussian distribution N(0, 1). It is understood that the CD method may also employ completely non-parametric change detection techniques, such as rank-based statistics, for example, which can be a good choice with exotic underlying probability distributions.

Since all data samples originate from the same distribution φ₀, namely a normal distribution, there is a high probability that the change statistic d_{N} remains below detection threshold h without triggering any alarms. Therefore, for each generated data stream, the change statistic d_{N} is computed and detection threshold h is set as the 99^{th} percentile of peak values. This process is iterated many time (e.g., 100,000 times), and a final value of detection threshold h to be used is the sample mean of the outcomes.

Recalibration after a change is now described. When a change is detected, there are two potential courses of action:
a. If a user deems the warning valid, appropriate corrective actions are taken, and the process ends. Monitoring starts again once the issue is resolved.
b. If the user deems the warning as unimportant, the method can be automatically reconfigured to work in the new post-change state. This might indicate a shift in the transmission enforced by the user and therefore considered acceptable. In practice, a new reference window w₀ is defined and descriptor vectors are then evaluated with respect to the new w₀. This ensures that the model remains aligned with the evolving operational context, enhancing its effectiveness and reducing further alarms. A warm-up period (requiring w samples) may be used to restart the method successfully.

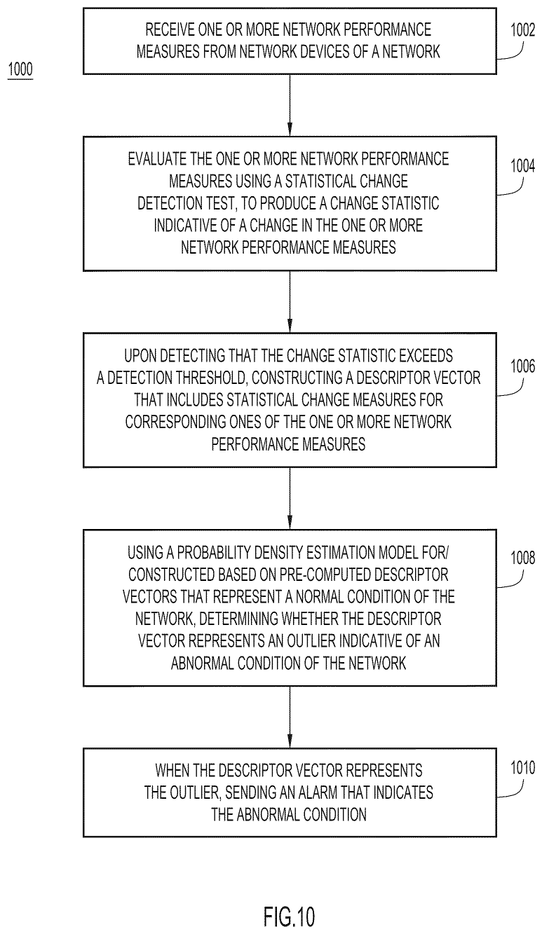

FIG. 10 is a flowchart of an example CD method 1000 performed by network monitor 106.

At 1002, the CD method 1000 receives time series values of one or more network performance measures from network devices of a network. For example, CD method 1000 receives time series values of multiple network performance measures.

At 1004, the CD method 1000 evaluates the one or more network performance measures to produce a change statistic indicative of a change in the one or more network performance measures. For example, the CD method 1000 measures dissimilarities of the time series values of the one or more network performance measures between multiple time windows of the time series values, to produce the change statistic. When the CD method 1000 receives multiple network performance measures, the CD method jointly evaluates the multiple network performance measures using a multivariate statistical change detection test, to produce the change statistic indicative of the change in the multiple network performance measures. For example, the CD method 1000 measures dissimilarities of the time series values of the multiple network performance measures between multiple time windows of the time series values, to produce the change statistic.

At 1006, upon detecting, at a detection time, that the change statistic exceeds a detection threshold, the CD method 1000 constructs a descriptor vector that includes one or more statistical change measures for corresponding ones of the one or more network performance measures. For example, the CD method 1000 computes each statistical change measure as at least one of a standard deviation change, a mean change, or a variance change of the time series values of each performance measure across the multiple time windows, which coincide with the detection time. In the case of multiple network performance measures, the CD method 1000 computes the statistical change measures for corresponding ones of the multiple network performance measures.

At 1008, using a probability density estimation model for/built on pre-computed descriptor vectors that represent a normal condition of the network, the CD method 1000 determines whether the descriptor vector represents an outlier (on the model) indicative of an abnormal condition of the network. The abnormal condition includes a failure condition or a degradation of the network, and the normal condition indicates an absence of the failure condition or the degradation.

In an example, the CD method 1000 determines that that the descriptor vector represents the outlier when the descriptor vector does not fall within a high-likelihood cluster of the probability density estimation model into which the pre-computed descriptor vectors are most likely to fall. On the other hand, the CD method 1000 determines that that the descriptor vector does not represent the outlier when the descriptor vector falls within the high-likelihood cluster.

The probability density estimation model may include an AI model trained in a semi-supervised manner exclusively on the pre-computed descriptor vectors constructed under normal conditions, and not abnormal conditions, of the network.

At 1010, when the descriptor vector represents the outlier, the CD method sends an alarm that indicates the abnormal condition. The CD method may present/display the alarm on a graphical user interface (GUI). For example, the GUI may present the following alarm text “An abnormal condition has been detected on the RON.” Many other types of alarms may be presented.

In summary, the CD method presented herein acquires PMs and uses them to monitor the status of data transmission by fiber links and to identify faults in the fiber links. Existing techniques are limited since they monitor individual PMs using transmission-dependent thresholds that should be fine-tuned, and operate shortly before breakdowns occur. The CD method advantageously detect faults jointly by considering multiple PMs (from one or more channels), with no prior knowledge of the RON, hence relaxing transmission-dependent thresholds. Moreover, the CD method detects issues when they appear, and before breakdowns occur.

The CD method approaches detecting faults as a change detection problem in which faults represent statistical changes. Specifically, the CD method operates as a semi-supervised hierarchical CD method integrating statistical and ML techniques. The CD method extracts a statistic (e.g., the normal discrepancy) from input PMs and identifies candidate changes as samples that exceed a detection threshold. These changes are then validated by building a descriptor vector that embeds relevant information of each change and feeding the descriptor vector to an outlier detection method (e.g., the KDE model). The alarm is triggered when there is sufficient statistical evidence to support an assertion that the descriptor vector associated with the identified change is anomalous.

The CD method provides real-time information with statistical guarantees, implementing an enhanced false alarm control, filtering out the changes in performance measures deemed significant for network operation.

The CD method monitors PMs and continuously analyzes the behavior of the RON, looking for changes over time. The foregoing analysis enables the identification of potential faults in fiber links or optical devices before potential faults escalate into major problems that could disrupt transmission. This allows a network operator to redirect network traffic before data loss, guaranteeing a high quality of service.

The CD method includes further features and advantages. Training of the CD model is semi-supervised, using exclusively non-anomalous PM data acquired under normal operating conditions, for example. That is, the CD method may be trained on data that avoids faulty configurations, which further avoids labeling fault data, i.e., faults/problems on the RON. The training data does not include labels to distinguish between normal and anomalous data (since all of the data in considered normal) for example.

The CD method discards irrelevant non-stationarities. More specifically, the validation layer processes candidate non-stationarities (changes in the statistical properties of the data streams) detected by the detection layer. These can correspond to irrelevant fluctuations (e.g., “system breath”). The validation layer is responsible for raising alarms only for the candidate non-stationarities corresponding to faults. The interaction between the detection and validation layers effectively discards non-stationarities associated with the normal operating conditions (e.g., “system breath”) and triggers alarms only when relevant non-stationarities occur, thus avoiding false alarms.

The CD method analyzes data in windows, adding to more robust evaluation and enabling the identification of patterns representing changes.

The CD method may be agnostic to network topology and data availability because the CD method does not rely on specific transmission configuration details (e.g., a RON configuration). In addition, the CD method assumes that the network topology is unknown and that no access to an internal optical line system that supports the fiber links in the network is available.

The CD method may be multivariate, in which case the CD method jointly monitors multiple PMs, simultaneously, offering a more comprehensive system analysis. In another example, the CD method can work in a univariate setting when a single PM is available.

### Computing Device (Network Monitor)

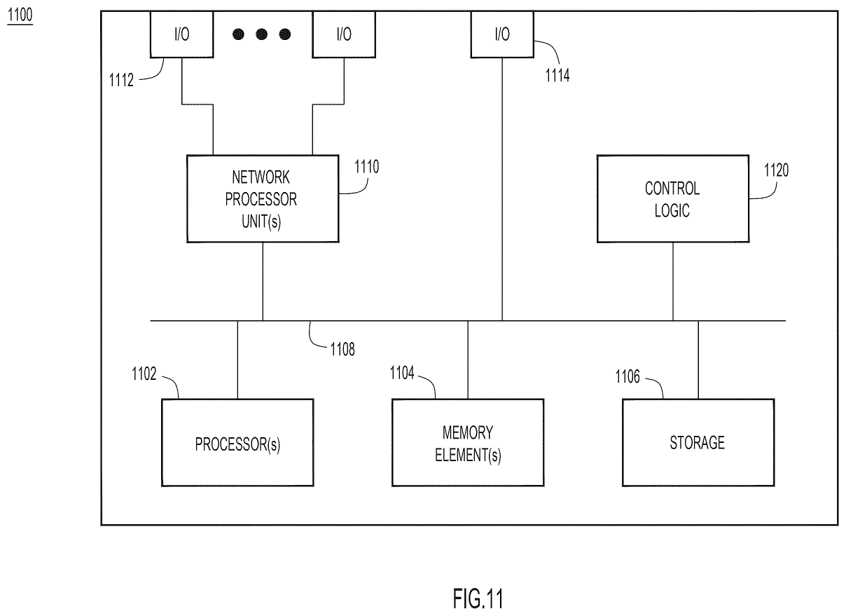

Referring to FIG. 11, FIG. 11 illustrates a hardware block diagram of a computing device 1100 that may perform functions associated with operations discussed herein in connection with the techniques depicted in FIGS. 1-10. In various embodiments, a computing device or apparatus, such as computing device 1100 or any combination of computing devices 1100, may be configured as any entity/entities as discussed for the techniques depicted in connection with FIGS. 1-10 in order to perform operations of the various techniques discussed herein. Computing device 1100 may represent network monitor 106 and each of optical network devices 104.

In at least one embodiment, the computing device 1100 may be any apparatus that may include one or more processor(s) 1102, one or more memory element(s) 1104, storage 1106, a bus 1108, one or more network processor unit(s) 1110 interconnected with (e.g., coupled to) one or more network input/output (I/O) interface(s) 1112, one or more I/O interface(s) 1114, and control logic 1120. In various embodiments, instructions associated with logic for computing device 1100 can overlap in any manner and are not limited to the specific allocation of instructions and/or operations described herein.

In at least one embodiment, processor(s) 1102 is/are at least one hardware processor configured to execute various tasks, operations and/or functions for computing device 1100 as described herein according to software and/or instructions configured for computing device 1100. Processor(s) 1102 (e.g., a hardware processor) can execute any type of instructions associated with data to achieve the operations detailed herein. In one example, processor(s) 1102 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 1104 and/or storage 1106 is/are configured to store data, information, software, and/or instructions associated with computing device 1100, and/or logic configured for memory element(s) 1104 and/or storage 1106. For example, any logic described herein (e.g., control logic 1120) can, in various embodiments, be stored for computing device 1100 using any combination of memory element(s) 1104 and/or storage 1106. Note that in some embodiments, storage 1106 can be consolidated with memory element(s) 1104 (or vice versa), or can overlap/exist in any other suitable manner.

In at least one embodiment, bus 1108 can be configured as an interface that enables one or more elements of computing device 1100 to communicate in order to exchange information and/or data. Bus 1108 can be implemented with any architecture designed for passing control, data and/or information between processors, memory elements/storage, peripheral devices, and/or any other hardware and/or software components that may be configured for computing device 1100. In at least one embodiment, bus 1108 may be implemented as a fast kernel-hosted interconnect, potentially using shared memory between processes (e.g., logic), which can enable efficient communication paths between the processes.

In various embodiments, network processor unit(s) 1110 may enable communication between computing device 1100 and other systems, entities, etc., via network I/O interface(s) 1112 (wired and/or wireless) to facilitate operations discussed for various embodiments described herein. In various embodiments, network processor unit(s) 1110 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 1100 and other systems, entities, etc. to facilitate operations for various embodiments described herein. In various embodiments, network I/O interface(s) 1112 can be configured as one or more Ethernet port(s), Fibre Channel ports, any other I/O port(s), and/or antenna(s)/antenna array(s) now known or hereafter developed. Thus, the network processor unit(s) 1110 and/or network I/O interface(s) 1112 may include suitable interfaces for receiving, transmitting, and/or otherwise communicating data and/or information in a network environment.

I/O interface(s) 1114 allow for input and output of data and/or information with other entities that may be connected to computing device 1100. For example, I/O interface(s) 1114 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 1120 can include instructions that, when executed, cause processor(s) 1102 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 1120) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, any entity or apparatus as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 1104 and/or storage 1106 can store data, software, code, instructions (e.g., processor instructions), logic, parameters, combinations thereof, and/or the like used for operations described herein. This includes memory element(s) 1104 and/or storage 1106 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™ mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

In various example implementations, any entity or apparatus for various embodiments described herein can encompass network elements (which can include virtualized network elements, functions, etc.) such as, for example, network appliances, forwarders, routers, servers, switches, gateways, bridges, loadbalancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

In some aspects, the techniques described herein relate to a method performed by a network monitor that communicates with network devices in a network, including: receiving one or more network performance measures from the network devices; evaluating the one or more network performance measures to produce a change statistic indicative of a change in the one or more network performance measures; upon detecting that the change statistic exceeds a detection threshold, constructing a descriptor vector that includes one or more statistical change measures for corresponding ones of the one or more network performance measures; using a probability density estimation model for pre-computed descriptor vectors that represent a normal condition of the network, determining whether the descriptor vector represents an outlier indicative of an abnormal condition of the network; and when the descriptor vector represents the outlier, sending an alarm that indicates the abnormal condition.

In some aspects, the techniques described herein relate to a method, further including: sending, to the network devices, requests for the one or more network performance measures, and wherein receiving includes receiving, from the network devices in response to sending, time series values of the one or more network performance measures, wherein evaluating includes using a statistical change detection test to measure dissimilarities of the time series values of the one or more network performance measures between multiple time windows of the time series values, to produce the change statistic indicative of the change in the one or more network performance measures.

In some aspects, the techniques described herein relate to a method, wherein: receiving includes receiving the time series values of multiple network performance measures; evaluating includes jointly evaluating the multiple network performance measures using a multivariate statistical change detection test to produce the change statistic; and constructing the descriptor vector includes constructing the descriptor vector to include multiple statistical change measures for the multiple network performance measures.

In some aspects, the techniques described herein relate to a method, wherein: constructing includes computing each statistical change measure as a standard deviation change, a mean change, or a variance change of the time series values of each performance measure across the multiple time windows.

In some aspects, the techniques described herein relate to a method, wherein: determining includes determining that the descriptor vector represents the outlier when the descriptor vector does not fall within a high-likelihood cluster of the probability density estimation model into which the pre-computed descriptor vectors are most likely to fall.

In some aspects, the techniques described herein relate to a method, wherein: the probability density estimation model includes a probability density model having one or more axes corresponding to the one or more statistical change measures of the one or more network performance measures.

In some aspects, the techniques described herein relate to a method, wherein: the probability density estimation model includes an artificial intelligence model trained exclusively on the pre-computed descriptor vectors constructed under normal conditions, and not abnormal conditions, of the network.

In some aspects, the techniques described herein relate to a method, wherein: the artificial intelligence model includes a kernel density estimation model.

In some aspects, the techniques described herein relate to a method, wherein: the network devices include optical network devices configured to communicate over optical fiber links, and the one or more network performance measures include one or more of optical transmission bit error rate, optical signal-to-noise ratio, optical receive power, and polarization dependent loss.

In some aspects, the techniques described herein relate to a method, wherein: the abnormal condition includes a failure condition or a degradation of the network, and the normal condition indicates an absence of the failure condition or the degradation.

In some aspects, the techniques described herein relate to an apparatus including: a network interface unit to communicate with network devices of a network; and a processor coupled to the network interface unit and configured to perform: receiving one or more network performance measures from the network devices; evaluating the one or more network performance measures to produce a change statistic indicative of a change in the one or more network performance measures; upon detecting that the change statistic exceeds a detection threshold, constructing a descriptor vector that includes one or more statistical change measures for corresponding ones of the one or more network performance measures; using a probability density estimation model for pre-computed descriptor vectors that represent a normal condition of the network, determining whether the descriptor vector represents an outlier indicative of an abnormal condition of the network; and when the descriptor vector represents the outlier, sending an alarm that indicates the abnormal condition.

In some aspects, the techniques described herein relate to an apparatus, wherein the processor is further configured to perform: sending, to the network devices, requests for the one or more network performance measures, and wherein the processor is configured to perform receiving by receiving, from the network devices in response to sending, time series values of the one or more network performance measures, wherein the processor is configured to perform evaluating by using a statistical change detection test to measure dissimilarities of the time series values of the one or more network performance measures between multiple time windows of the time series values, to produce the change statistic indicative of the change in the one or more network performance measures.

In some aspects, the techniques described herein relate to an apparatus, wherein the processor is configured to perform: receiving by receiving the time series values of multiple network performance measures; evaluating by jointly evaluating the multiple network performance measures using a multivariate statistical change detection test to produce the change statistic; and constructing the descriptor vector by constructing the descriptor vector to include multiple statistical change measures for the multiple network performance measures.

In some aspects, the techniques described herein relate to an apparatus, wherein: wherein the processor is configured to perform constructing by computing each statistical change measure as a standard deviation change, a mean change, or a variance change of the time series values of each performance measure across the multiple time windows.

In some aspects, the techniques described herein relate to an apparatus, wherein: wherein the processor is configured to perform determining by determining that the descriptor vector represents the outlier when the descriptor vector does not fall within a high-likelihood cluster of the probability density estimation model into which the pre-computed descriptor vectors are most likely to fall.

In some aspects, the techniques described herein relate to an apparatus, wherein: the probability density estimation model includes a probability density model having one or more axes corresponding to the one or more statistical change measures of the one or more network performance measures.

In some aspects, the techniques described herein relate to an apparatus, wherein: the probability density estimation model includes an artificial intelligence model trained exclusively on the pre-computed descriptor vectors constructed under normal conditions, and not abnormal conditions, of the network.

In some aspects, the techniques described herein relate to a non-transitory computer readable medium encoded with instructions that, when executed by a processor of a network monitor that communicates with network devices in a network, causes the processor to perform: receiving one or more network performance measures from the network devices; evaluating the one or more network performance measures to produce a change statistic indicative of a change in the one or more network performance measures; upon detecting that the change statistic exceeds a detection threshold, constructing a descriptor vector that includes one or more statistical change measures for corresponding ones of the one or more network performance measures; using a probability density estimation model for pre-computed descriptor vectors that represent a normal condition of the network, determining whether the descriptor vector represents an outlier indicative of an abnormal condition of the network; and when the descriptor vector represents the outlier, sending an alarm that indicates the abnormal condition.

In some aspects, the techniques described herein relate to a non-transitory computer readable medium, further including instructions to cause the processor to perform: sending, to the network devices, requests for the one or more network performance measures, and wherein the instructions to cause the processor to perform receiving include instructions to cause the processor to perform receiving, from the network devices in response to sending, time series values of the one or more network performance measures, wherein the instructions to cause the processor to perform evaluating include instructions to cause the processor to perform using a statistical change detection test to measure dissimilarities of the time series values of the one or more network performance measures between multiple time windows of the time series values, to produce the change statistic indicative of the change in the one or more network performance measures.

In some aspects, the techniques described herein relate to a non-transitory computer readable medium, wherein: the instructions to cause the processor to perform receiving include instructions to cause the processor to perform receiving the time series values of multiple network performance measures; the instructions to cause the processor to perform evaluating include instructions to cause the processor to perform jointly evaluating the multiple network performance measures using a multivariate statistical change detection test to produce the change statistic; and the instructions to cause the processor to perform constructing the descriptor vector include instructions to cause the processor to perform constructing the descriptor vector to include multiple statistical change measures for the multiple network performance measures.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method performed by a network monitor that communicates with network devices in a network, comprising:
receiving one or more network performance measures from the network devices;
evaluating the one or more network performance measures to produce a change statistic indicative of a change in the one or more network performance measures;
upon detecting that the change statistic exceeds a detection threshold, constructing a descriptor vector that includes one or more statistical change measures for corresponding ones of the one or more network performance measures;
using a probability density estimation model for pre-computed descriptor vectors that represent a normal condition of the network, determining whether the descriptor vector represents an outlier indicative of an abnormal condition of the network; and
when the descriptor vector represents the outlier, sending an alarm that indicates the abnormal condition.

2. The method of claim 1, further comprising:
sending, to the network devices, requests for the one or more network performance measures, and
wherein receiving includes receiving, from the network devices in response to sending, time series values of the one or more network performance measures,
wherein evaluating includes using a statistical change detection test to measure dissimilarities of the time series values of the one or more network performance measures between multiple time windows of the time series values, to produce the change statistic indicative of the change in the one or more network performance measures.

3. The method of claim 2, wherein:
receiving includes receiving the time series values of multiple network performance measures;
evaluating includes jointly evaluating the multiple network performance measures using a multivariate statistical change detection test to produce the change statistic; and
constructing the descriptor vector includes constructing the descriptor vector to include multiple statistical change measures for the multiple network performance measures.

4. The method of claim 2, wherein:
constructing includes computing each statistical change measure as a standard deviation change, a mean change, or a variance change of the time series values of each performance measure across the multiple time windows.

5. The method of claim 1, wherein:
determining includes determining that the descriptor vector represents the outlier when the descriptor vector does not fall within a high-likelihood cluster of the probability density estimation model into which the pre-computed descriptor vectors are most likely to fall.

6. The method of claim 1, wherein:
the probability density estimation model includes a probability density model having one or more axes corresponding to the one or more statistical change measures of the one or more network performance measures.

7. The method of claim 1, wherein:
the probability density estimation model includes an artificial intelligence model trained exclusively on the pre-computed descriptor vectors constructed under normal conditions, and not abnormal conditions, of the network.

8. The method of claim 7, wherein:
the artificial intelligence model includes a kernel density estimation model.

9. The method of claim 1, wherein:
the network devices include optical network devices configured to communicate over optical fiber links, and the one or more network performance measures include one or more of optical transmission bit error rate, optical signal-to-noise ratio, optical receive power, and polarization dependent loss.

10. The method of claim 1, wherein:
the abnormal condition includes a failure condition or a degradation of the network, and the normal condition indicates an absence of the failure condition or the degradation.

11. An apparatus comprising:
a network interface unit to communicate with network devices of a network; and
a processor coupled to the network interface unit and configured to perform:
receiving one or more network performance measures from the network devices;
evaluating the one or more network performance measures to produce a change statistic indicative of a change in the one or more network performance measures;
upon detecting that the change statistic exceeds a detection threshold, constructing a descriptor vector that includes one or more statistical change measures for corresponding ones of the one or more network performance measures;
using a probability density estimation model for pre-computed descriptor vectors that represent a normal condition of the network, determining whether the descriptor vector represents an outlier indicative of an abnormal condition of the network; and
when the descriptor vector represents the outlier, sending an alarm that indicates the abnormal condition.

12. The apparatus of claim 11, wherein the processor is further configured to perform:
sending, to the network devices, requests for the one or more network performance measures, and
wherein the processor is configured to perform receiving by receiving, from the network devices in response to sending, time series values of the one or more network performance measures,
wherein the processor is configured to perform evaluating by using a statistical change detection test to measure dissimilarities of the time series values of the one or more network performance measures between multiple time windows of the time series values, to produce the change statistic indicative of the change in the one or more network performance measures.

13. The apparatus of claim 12, wherein the processor is configured to perform:
receiving by receiving the time series values of multiple network performance measures;
evaluating by jointly evaluating the multiple network performance measures using a multivariate statistical change detection test to produce the change statistic; and
constructing the descriptor vector by constructing the descriptor vector to include multiple statistical change measures for the multiple network performance measures.

14. The apparatus of claim 12, wherein:
wherein the processor is configured to perform constructing by computing each statistical change measure as a standard deviation change, a mean change, or a variance change of the time series values of each performance measure across the multiple time windows.

15. The apparatus of claim 11, wherein:
wherein the processor is configured to perform determining by determining that the descriptor vector represents the outlier when the descriptor vector does not fall within a high-likelihood cluster of the probability density estimation model into which the pre-computed descriptor vectors are most likely to fall.

16. The apparatus of claim 11, wherein:
the probability density estimation model includes a probability density model having one or more axes corresponding to the one or more statistical change measures of the one or more network performance measures.

17. The apparatus of claim 11, wherein:
the probability density estimation model includes an artificial intelligence model trained exclusively on the pre-computed descriptor vectors constructed under normal conditions, and not abnormal conditions, of the network.

18. A non-transitory computer readable medium encoded with instructions that, when executed by a processor of a network monitor that communicates with network devices in a network, causes the processor to perform:
receiving one or more network performance measures from the network devices;
evaluating the one or more network performance measures to produce a change statistic indicative of a change in the one or more network performance measures;
upon detecting that the change statistic exceeds a detection threshold, constructing a descriptor vector that includes one or more statistical change measures for corresponding ones of the one or more network performance measures;
using a probability density estimation model for pre-computed descriptor vectors that represent a normal condition of the network, determining whether the descriptor vector represents an outlier indicative of an abnormal condition of the network; and
when the descriptor vector represents the outlier, sending an alarm that indicates the abnormal condition.

19. The non-transitory computer readable medium of claim 18, further comprising instructions to cause the processor to perform:
sending, to the network devices, requests for the one or more network performance measures, and
wherein the instructions to cause the processor to perform receiving include instructions to cause the processor to perform receiving, from the network devices in response to sending, time series values of the one or more network performance measures,
wherein the instructions to cause the processor to perform evaluating include instructions to cause the processor to perform using a statistical change detection test to measure dissimilarities of the time series values of the one or more network performance measures between multiple time windows of the time series values, to produce the change statistic indicative of the change in the one or more network performance measures.

20. The non-transitory computer readable medium of claim 19, wherein:
the instructions to cause the processor to perform receiving include instructions to cause the processor to perform receiving the time series values of multiple network performance measures;
the instructions to cause the processor to perform evaluating include instructions to cause the processor to perform jointly evaluating the multiple network performance measures using a multivariate statistical change detection test to produce the change statistic; and
the instructions to cause the processor to perform constructing the descriptor vector include instructions to cause the processor to perform constructing the descriptor vector to include multiple statistical change measures for the multiple network performance measures.
